(19) United States
(12) Patent Application Publication
(10) Pub. No.: US 2009/0122257 A1
(43) Pub. Date: May 14, 2009

(54) Eyeglasses structure

(76) Inventor: Chih-Chang Huang, Anding Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,960

(22) Filed: Nov. 13, 2007

(51) Int. Cl. G02C 5/00

(52) U.S. Cl. 351/140

(57) ABSTRACT

The present invention relates to an eyeglasses structure having an eyeglass body and temples, wherein tenons are formed on both sides of said eyeglass body, each said tenon is provided with tenon feet on which engaging portions are provided on the end edges; a connection portion is provided on each temple, which is formed by the fitting of two opposite casings; retaining recesses with big arc edge variation corresponding to the shape of the engaging portions on the tenon feet being provided on the casings, a slot being formed after said retaining recesses provided on the casings are oppositely fitted together so as to correspondingly engage with said tenons. According to this structure, the slot having retaining recesses with bigger arc edge variation can be engaged with the tenons of the eyeglass body so as to form a stable combination.

### BACKGROUND OF THE INVENTION

1. Field of the Invention

The present invention relates to an eyeglasses structure, particularly to an eyeglasses structure having an eyeglass body and temples, in which tenons are formed on both sides of the eyeglass body; a connection portion is provided on each temple, which is formed by the fitting of two opposite casings; retaining recesses with big arc edge variation being provided on the casings, a slot being formed after the retaining recesses provided on the casings are oppositely fitted together so as to correspondingly engage with the engaging portions of the tenons.

2. Brief Description of the Prior Art

Accompanying with the fast-growing of televisions and computers, the proportion of people having myopia increases and the age group having myopia has shifted to younger generation year by year. Thus, the number of people needs to wear eyeglasses for vision correction which grows year by year. In order to meet the demands of eyeglasses coming from consumers having different tastes and needs, the variations on the appearance design other than the essential function of vision correction is also appreciated.

In FIGS. 7 and 8, the eyeglasses (3) enabling change of eyeglass body (31) and temples (32) and developed by concerned industry are shown, in which tenons (311) are integrally formed on both sides of the eyeglass body (31). Tenons (311) on each side have two tenon feet (312) on which engaging portions (313) are projectingly provided on the side edges. Further, a connection portion (33) molded integrally is provided at the front end of each tenon foot (312) and a slot (331) for engaging is provided on the connection portion (33). Retaining recesses (332) for the engagement with the tenons (311) of the eyeglass body (31) are provided at the end of the slot (331). The engaging portions (313) of the tenons (311) are tightly engaged with the retaining recesses (332) of the slot (331) during engagement.

So far, the molding for the connection portion (33) and its slot (331) of the eyeglasses (3) is conducted by a female mold in which a cavity for molding the connection portion (33) is provided and a male mold is embedded within the cavity of the female mold so as to form the slot (331) and the retaining recesses (332).

For the convenience of mold stripping, the retaining recesses (332) having excessive depth is not allowed in the molding of the connection portion (33) with its slot (331) so as to avoid the difficulty in mold stripping of the male mold for molding the retaining recesses (332) from the slot (331) after the injection molding of the connection portion (33) is conducted. If an enforced stripping of the male mold from the cavity of the female mold is conducted, there is a possibility to cause the damage of the retaining recesses (332).

Thus, under the situation that the retaining recesses (332) having excessive depth is not allowed in the molding of the connection portion (33) with its slot (331), the engaging portions (313) provided on the tenons (311) for engaging with the retaining recesses (332) can only be molded correspondingly as projections with small height.

In the case that an engagement of small depth between the retaining recesses (332) of the slot (331) and the engaging portion (313) of the tenons (311) is conducted, the retention force between them is not sufficient such that the connection between the eyeglass body (31) and the connection portion (33) of the temples (32) is caused to separate even upon application of a small force on it in practical use.

In view of the above defects, the inventor of this invention thus proposes a new eyeglasses structure according to research and improvement made with respect to the existing structure after continuous devotion to the product development and design based on the experience and the knowledge accumulated in the long term involvement of relevant field. Therefore, higher practical performance of the eyeglasses can be further anticipated.

### SUMMARY OF THE INVENTION

The main object of this invention is to provide an eyeglasses structure which can provide engagement stability for the combination of eyeglass body and temples that are detachable and are intended for color or appearance design change.

Hence, tenons are formed on both sides of the eyeglass body and the tenons on each side have tenon feet on which engaging portions are provided on the side edges. Further, a connection portion is provided on each temple, which is formed by the fitting of two opposite casings. Retaining recesses having big arc edge variation are provided on the casings in such a manner as to correspond to the shape of the engaging portions on the tenons. The two opposite retaining recesses provided on the casings are fitted together to form a slot. According to this structure, the tenons and the slot can be concretely and stably engaged together by the retaining recesses having big arc edge.

### BRIEF DESCRIPTION OF THE DRAWINGS

The present invention will be better understood by the detailed description of preferred embodiments with reference to the accompanied drawings, in which:

FIG. 1 is a perspective exploded view of the eyeglasses of the present invention.

FIG. 2 is a partially enlarged perspective view (I) of the eyeglasses of the present invention.

FIG. 3 is a partially enlarged perspective view (II) of the eyeglasses of the present invention.

FIG. 4 is a partially enlarged perspective view (III) of the eyeglasses of the present invention.

FIG. 5 is a partially enlarged perspective view (IV) of the eyeglasses of the present invention.

FIG. 6 is a perspective assembled view of the eyeglasses of the present invention.

FIG. 7 is a perspective exploded view of the eyeglasses of a prior art.

FIG. 8 is a sectional view of a prior art.

### DETAILED DESCRIPTION OF THE PREFERRED EMBODIMENTS

The technical content, objects and effectiveness of the present invention will become more apparent by the detailed description in conjunction with the accompanied drawings.

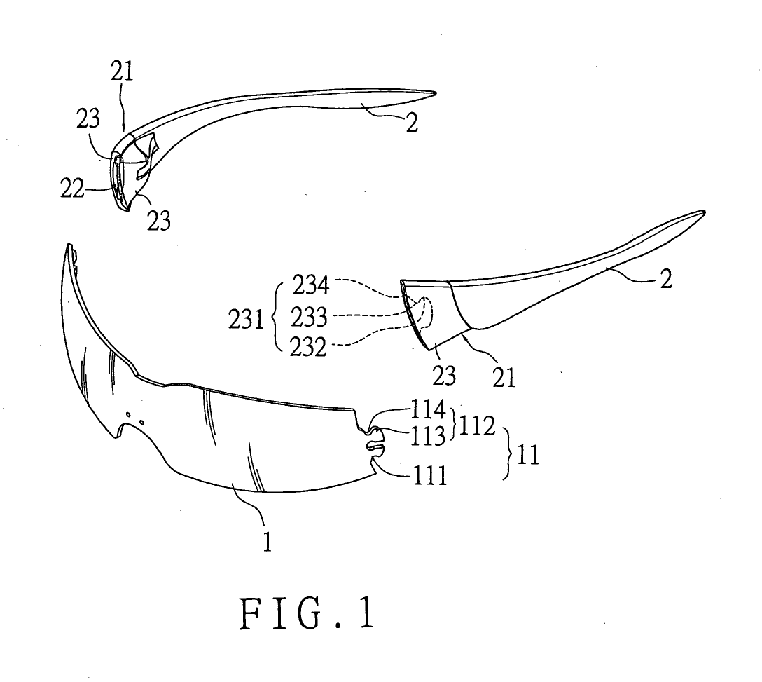

Firstly referring to FIG. 1, in which the eyeglasses of the present invention is shown to comprise the eyeglass body (1) and the temples (2).

The tenons (11) are integrally formed on both sides of the eyeglass body (1), which have tenon feet (111) on each side. And then, engaging portions (112) are projectingly provided on the end edges of the tenon feet (111).

A connection portion (21) is provided on each temple (2) and a slot (22) is provided on the connection portion (21) for engaging with the tenon (11) of the eyeglass body (1).

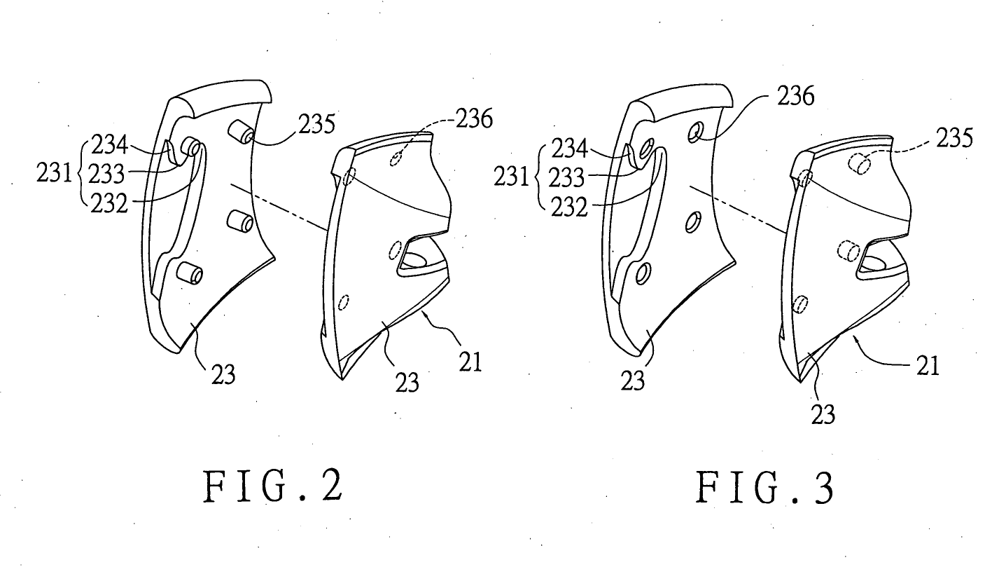

Referring to FIG. 2, the connection portion (21) is formed by the fitting of two opposite casings (23). Retaining recesses (231) are formed respectively into concave arc edges (232) on which the positioning convex arc segments (233) are formed to extend inward from both sides. The engaging portions (112) provided on the side edges of the tenon feet (111) of the tenons (11) are formed with convex arc edges (113) corresponding to the shape of the retaining recesses (231) for engaging with the concave arc edges (232) of the retaining recesses (231). Further, positioning concave arc segments (114) follows after the convex arc edges (113) so as to engage correspondingly with the positioning convex arc segments (233) provided on the retaining recess (231). And then, arc shape openings (234) are connected with the positioning convex arc segments (233). Moreover, the positioning concave arc segments (114) is followed after the tenon feet (111) so as to correspond to the opening portion (234) provided on each slot (231).

Then, the retaining recesses (231) provided on the two casings (23) are oppositely fitted together to form the slot (22).

In this manner, the design of molding the connection portion (21) by jointing two casings (23) can enable the molding of the retaining recesses (231) of the casings (23) with a bigger arc edge in the injection molding process of the casings (23) respectively such that damage during the mold stripping will not happen, wherein the casings (23) are molded by injecting plastic material into the cavity between a male mold and a female mold oppositely abutted together in the upper and lower direction, and the male mold is lifted to separate from the female mold after the completion of the casings (23).

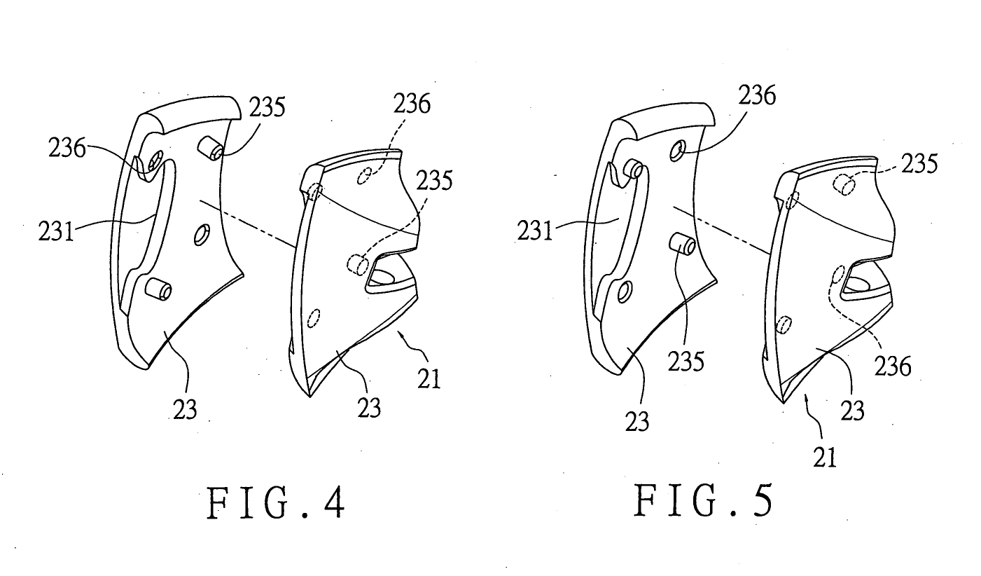

Referring to FIGS. 2 and 3, bosses (235) and holes (236) are formed respectively on the two casings (23) to fit correspondingly together. The bosses (235) can be formed on one of the two casings, while the holes (236) on the other casing. Alternatively, as shown in FIGS. 4 and 5, both casings (23) can be provided with bosses (235) and holes (236) so as to fit correspondingly with the holes (236) and bosses (235) with each other.

According to this structure, as shown in FIGS. 1 and 2, the two casings (23) of the connection portion (21) are oppositely fitted together in the assembling process such that the retaining recesses (231) of the two casings (23) thus oppositely fitted together form a slot (22).

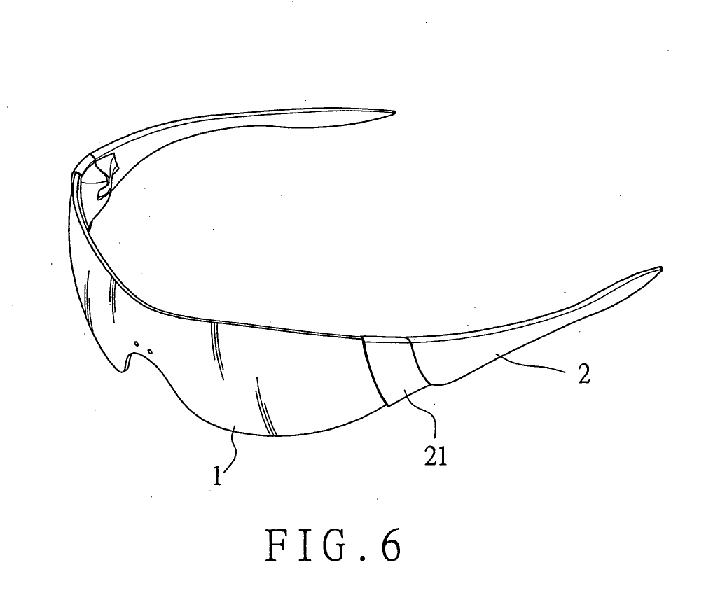

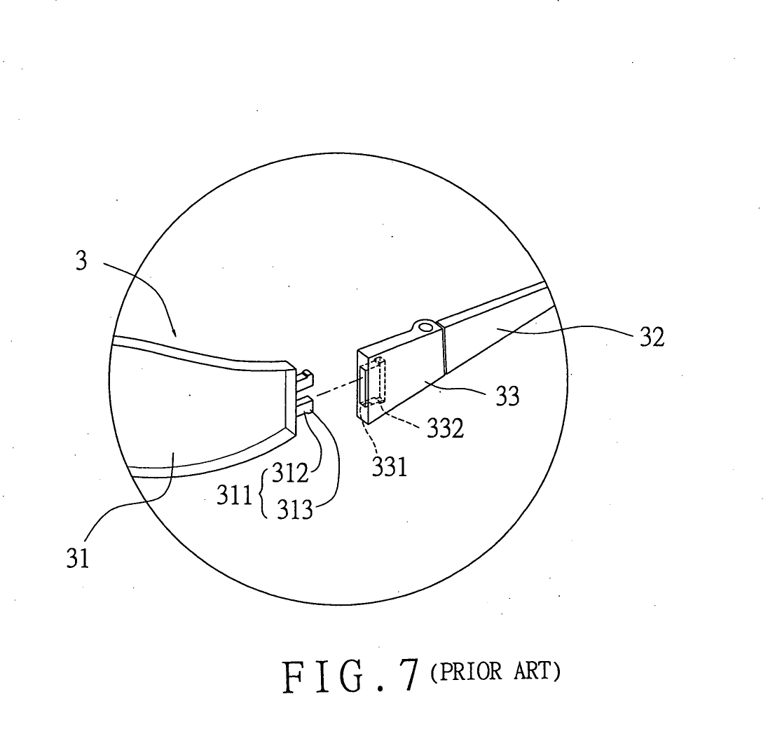

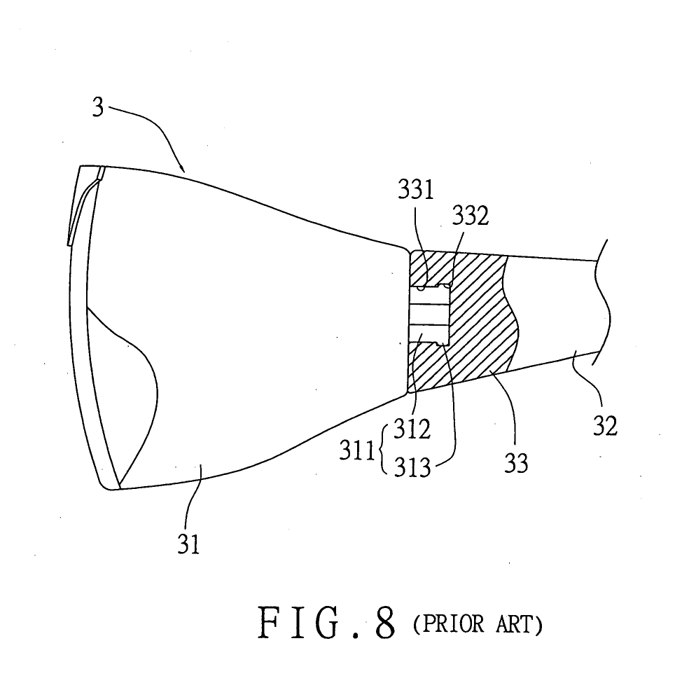

Subsequently, the tenons (11) provided on the eyeglass body (1) are inserted correspondingly into the slot (22) of the connection portion (21) so that a stable integral combination between the two can be achieved by the mutual engagement of big arc edge between the engaging portion (112) of the tenons (11) and retaining recesses (231) of the slot (22), as shown in FIG. 6.

In practical application of the eyeglasses, neither the mutual stably combined eyeglass body (1) and the connection portion (21) of the temples (2) will come off upon application of a small force from a user on the eyeglass body (1), nor the eyeglass body (1) and the temples (2) will strip off by the oppression coming from outside.

When a pull force is applied oppositely between the eyeglass body (1) and the connection portion (21), the tenons (11) of the eyeglass body (1) will come out from the slot (22) of the connection portion (21) along the arc edge of the retaining recesses (231). In this manner, the user can change the eyeglass body (1) and the temples (2) with different colors or appearance designs for aesthetic pleasing.

Based on the foregoing structure and embodiment, the present invention has advantages listed as below:

(1) the connection portion of the temples of the present invention is molded by oppositely fitting of two casings such that the two casing having bigger arc edges can be easily produced by the injection molding. According to this structure, when the connection portion is molded by oppositely fitting of the two casings, the retaining recesses form the slot. The slot having retaining recesses with bigger arc edge can be engaged with the tenons of the eyeglass body so as to form a stable combination.

(2) the design of combination arc edge between the slot provided on the connection portion of the temples and the tenons of the eyeglass body only allows the tenons of the eyeglass body come out from the slot of the connection portion along the arc edge of the retaining recesses when a pull force is applied between the eyeglass body and the connection portion in opposite direction. In this manner, the user can change the eyeglass body and the temples with different colors or appearance designs for aesthetic pleasing.

Summing up above, the embodiment of this invention can reach expected effectiveness, and the specific configurations disclosed herein have yet not seen in the prior art of the same category of product, even has not been opened to the public before application.

Additional advantages and modifications will readily occur to those skilled in the art. Therefore, this invention in its broader aspects is not limited to the specific details and representative embodiment shown and described herein. Accordingly, various modifications and variations may be made without departing from the spirit and scope of the general inventive concept as defined by the appended claims and their equivalents.

1. An eyeglasses having an eyeglass body and eyeglass feet, comprising:
tenons formed on both sides of said eyeglass body, each said tenon being provided with tenon feet on which engaging portions are provided on the end edges thereof; and
a connection portion provided on each eyeglass foot, which is formed by the fitting of two opposite casings, retaining recesses corresponding to the shape of the engaging portions on the tenon feet being provided on the casings, a slot being formed after said retaining recesses provided on the casings are oppositely fitted together so as to correspondingly engage and enclose said tenons.

2. The eyeglasses as claimed in claim 1, wherein said two casings of said connection portion are provided with bosses and holes for corresponding fitting.

3. The eyeglasses as claimed in claim 2, wherein said bosses are provided on one of the casings, while the holes are provided on the other casing for fitting with said bosses.

4. The eyeglasses as claimed in claim 2, wherein each of said two casings is provided with bosses and holes for correspondingly fitting with the holes and the bosses of the other casing.

5. An eyeglasses having an eyeglass body and eyeglass feet, comprising:
tenons formed on both sides of said eyeglass body, each said tenon being provided with tenon feet on which engaging portions are provided on end edges thereof; and
a connection portion provided on each eyeglass foot and formed by the fitting of two opposite casings, the casings being provided with retaining recesses corresponding to a shape of the engaging portions on the tenon feet, a slot being formed after said retaining recesses provided on the casings are oppositely fitted together so as to correspondingly engage with said tenons, the retaining recesses of the connection portion of said eyeglass feet being formed respectively into concave arc edges on which the positioning convex arc segments are formed to extend inward from both sides, and arc shape openings being connected with said positioning convex arc segments; the engaging portions provided on the side edges of the tenon feet of said tenons being formed with convex arc edges corresponding to the shape of the retaining recesses for engaging with the concave arc edges of the retaining recesses; further, positioning concave arc segments follows after the convex arc edges so as to engage correspondingly with the positioning convex arc segments provided on each retaining recess; moreover, the positioning concave arc segments follow after the tenon feet so as to correspond to the opening portion provided on the slot.

6. The eyeglasses as claimed in claim 5, wherein said two casings of said connection portion are provided with bosses and holes for corresponding fitting.

7. The eyeglasses as claimed in claim 6, wherein said bosses are provided on one of the casings, while the holes are provided on the other casing for fitting with said bosses.

8. The eyeglasses as claimed in claim 6, wherein each of said two casings is provided with bosses and holes for correspondingly fitting with the holes and the bosses of the other casing.
